(19) United States
(12) Patent Application Publication
(10) Pub. No.: US 2005/0189685 A1
(43) Pub. Date: Sep. 1, 2005

(54) Dual spring rate preload module with air adjustment

(76) Inventor: Frank Verriet, Mississauga (CA)

Correspondence Address: CARLSON, GASKEY & OLDS, P.C., 400 WEST MAPLE ROAD, SUITE 350, BIRMINGHAM, MI, 48009, US

(21) Appl. No.: 10/790,501

(22) Filed: Mar. 1, 2004

(51) Int. Cl. B60G 11/56

(52) U.S. Cl. 267/34

(57) ABSTRACT

A preload shock absorber assembly includes a shock absorber having a hydraulic cylinder. The cylinder includes a rod slideably supported by a cylinder head having a seal at one end of the hydraulic cylinder. A preload air chamber is arranged radially outwardly of the rod seal to provide a first spring having a first spring rate. The pressurized preload air chamber is separated from the rod seal to prevent loss of pressurized from the preload air chamber to the hydraulic cylinder. The pressurized air chamber uses a movable separator that seals the air chamber and isolates the air chamber from the outside environment. A second spring is supported by a seat secured to the hydraulic cylinder outer wall and is arranged between the seat and the separator. A third spring is arranged within the air chamber to supplement the spring rate provided by the pressurized air chamber.

### BACKGROUND OF THE INVENTION

This invention relates to a preload shock absorber, and more particularly, this invention relates to a preload shock absorber having a preload chamber filled with compressible fluid.

Air adjustable preload shock absorbers are used for recreational and small vehicles such as motorcycles, ATVs and snowmobiles to adjust the vehicle ride height and spring rate. The preload is adjusted by filling an air chamber for greater vehicle loads, such as multiple passengers, or evacuating the chamber for lighter loads. Under any loading condition, the air chamber is pressurized to some degree to provide a desired spring preload attributable to the pressurized air, also affecting the spring rate to some degree.

In one preload shock absorber arrangement used for motorcycles, a preload air chamber is provided at one end of the shock absorber around the rod. A wall is arranged around the rod to provide the preload air chamber, which is adjacent to a cylinder head and rod seal supporting the rod. The wall is sealed relative to the outer cylinder wall of the shock absorber. The rod seal separates the pressurized air in the air chamber from the pressurized hydraulic fluid within the shock absorber. However, the pressurized air can leak past the rod seal entering the shock absorber, which is perceived as a loss of air pressure within the air chamber resulting in an unacceptable ride height and spring rate. Losing pressurized air unexpectedly results in undesirable ride quality and may force an immediate repair by the vehicle operator.

To address this problem, a preload shock absorber has been designed with a mechanical spring arranged within the air chamber so that if pressure is lost within the air chamber, a preload and spring rate will still be provided by the mechanical spring. Since the mechanical spring is located between the cylinder head and rod end, a single mechanical spring may significantly increase the dead length of the shock absorber so that two concentric springs have been arranged have been used to shorten the length. However, the use of this mechanical spring does not address the root cause of the unexpected loss of pressurized air.

Therefore, what is needed is a preload shock absorber that has a preload air chamber that is less susceptible to losing pressurized air.

### SUMMARY OF THE INVENTION

The present invention provides a preload shock absorber assembly including a shock absorber having a hydraulic cylinder. The cylinder includes a rod slideably supported by a cylinder head having a seal at one end of the hydraulic cylinder. A preload air chamber is arranged radially outwardly of the rod seal, and in one embodiment shown, radially outwardly of an outer wall of the hydraulic cylinder, to provide a first spring having a first spring rate. The pressurized preload air chamber is separated from the rod seal to prevent loss of pressurized air past the rod seal from the preload air chamber to the hydraulic cylinder. The pressurized air chamber uses a movable separator that seals the air chamber and isolates the air chamber from the outside environment. A second spring is supported by a seat secured to the hydraulic cylinder outer wall and is arranged between the seat and the separator. A third spring is arranged within the air chamber to supplement the spring rate provided by the pressurized air chamber.

The spring rate provided by the pressurized air chamber and the third spring are arranged in parallel to one another and, together, in series with the second spring. Since the pressurized air chamber is arranged radially outwardly from the rod seal, the preload air chamber will not lose pressurized air through the rod seal. Having the second spring arranged in series with the spring rate provided by the pressurized air chamber and the third spring reduces the length that the separator and its seals move during a shock stroke, which increases seal life and reduces possibility of pressurized air loss past the seals.

Accordingly, the inventive preload shock absorber provides a preload air chamber that is less acceptable to losing pressurized air.

These and other features of the present invention can be best understood from the following specification and drawings, the following of which is a brief description.

### BRIEF DESCRIPTION OF THE DRAWINGS

FIG. 1 is perspective view of the inventive preload shock absorber.

FIG. 2 is a cross-sectional view of the preload shock absorber shown in FIG. 1 taken along lines 2-2.

FIG. 3 is an enlarged cross-sectional view of the preload air chamber shown in FIG. 2.

### DETAILED DESCRIPTION OF THE PREFERRED EMBODIMENT

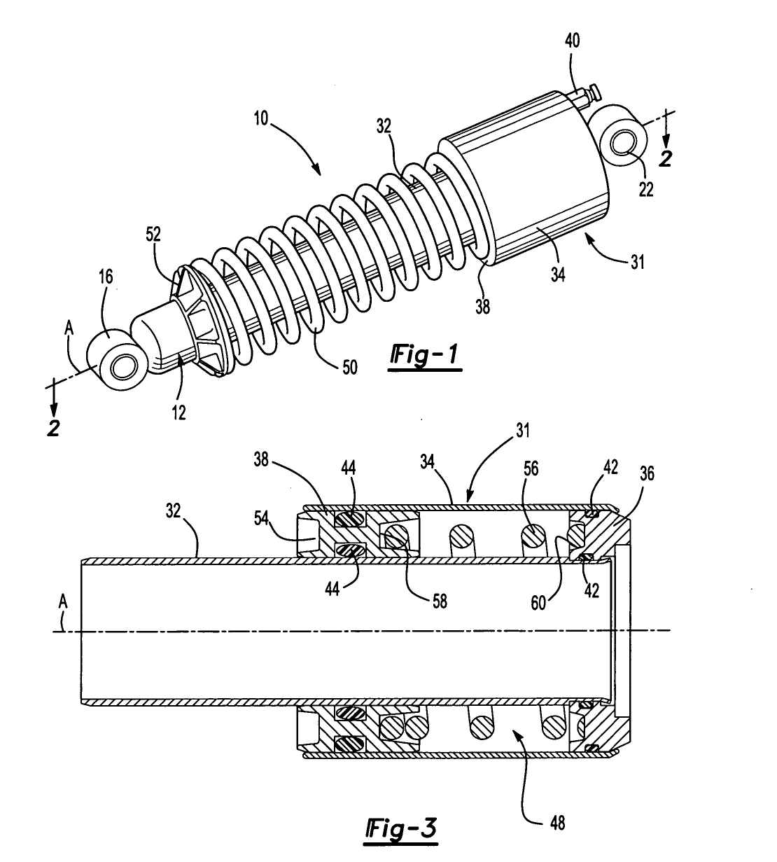

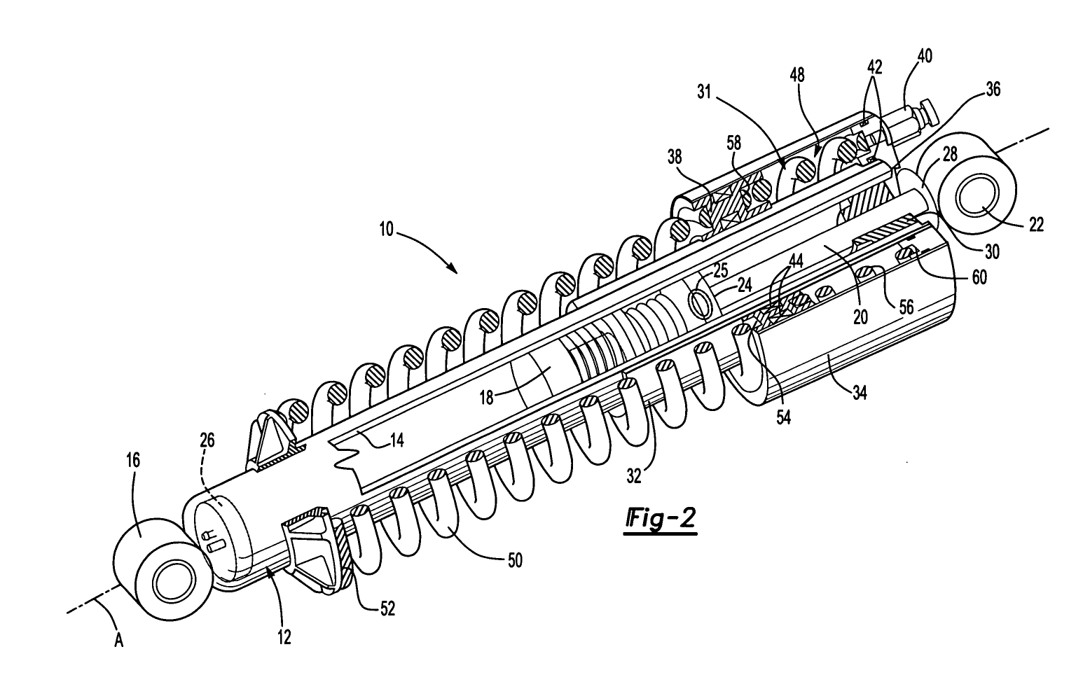

A preload shock absorber assembly 10 is shown in FIGS. 1 and 2 that includes a shock absorber 12 having a hydraulic cylinder 14. The shock absorber 12 includes a first end 16 secured to the hydraulic cylinder 14 for attachment to a vehicle suspension. A piston 18 is arranged in the hydraulic cylinder 14 and is connected to a rod 20 having a second end 22 that is attached to a vehicle frame. The rod 20 is supported for axial movement by a cylinder head 24 arranged in an end of the hydraulic cylinder 14 opposite the first end 16. A base valve 26 is arranged in the hydraulic cylinder 14 opposite the cylinder head 24. Valves in the base valve 26 and piston 18 regulate the flow of hydraulic fluid there through to provide desired damping characteristics for the assembly 10, as is well know in the art.

A rod seal 25 is arranged between the rod 20 and cylinder head 24 to retain the hydraulic fluid within the hydraulic cylinder 14 under pressure and prevent air from entering the cylinder 14. With prior art designs this rod seal 25 has been known to fail when subjected to pressurized air from the adjacent pressured preload air chamber. To this end, the inventive preload shock absorber assembly 10 arranges a pressurized preload air chamber 31 radially outwardly from the rod seal 25 so as to only expose the rod seal 25 to unpressurized, atmospheric air instead of pressurized air. That is, the pressurized air circuit of the preload air chamber 31 is separated from the pressurized hydraulic circuit within the hydraulic cylinder 14.

Referring to FIGS. 2 and 3, the preload air chamber 31 includes an inner wall 32 that is arranged radially outwardly of the outer wall of the hydraulic cylinder 14 but need not be sealed relative to the outer wall. As a result, the cavity arranged between the inner wall 32 and the rod 20 is unpressurized exposing the rod seal 25 to atmospheric air. An outer wall 34 is arranged radially outwardly of the inner wall 32. An end cap 36 extends radially from the inner wall 32 to the outer wall 34, and the ends of the inner 32 and outer 34 walls are mechanically fixed to axially retain the end cap 36. First 28 and second 30 members clamp the end cap 36 to axially retain the end cap 36 on the end of the rod 20. A fluid connection 40 having a check valve is supported on the end cap 36, and for motorcycle applications, is removably connected to a pressurized air source.

End cap seals 42 are arranged between the inner 32 and outer 34 walls to prevent loss of air pressure. A separator 38 is arranged opposite the end cap 36 and is axially movable relative to the inner 32 and outer 34 walls. Separator seals 44 are arranged between the separator 38 and inner 32 and outer 34 walls to prevent loss of pressurized air. The inventive arrangement reduces the length that the separator moves during the shock stroke as compared with prior art arrangements, which will be appreciated from the discussion below.

The walls 32, 34, end cap 36, separator 38 and the associated seals 42, 44 provide a preload air chamber 48 filled with compressed air that provides a first spring. A seat 52 is secured to the outer wall of the hydraulic cylinder 14 opposite the preload air chamber 31. A second spring 50, which is a helical spring in the example shown, is supported between the seat 52 and a first annular groove in the separator 38. A third spring 56, which is another helical spring in the example shown, is arranged in the air chamber 48 to provide a preload spring force in the event pressurized air is lost from the air chamber 48. The third spring 56 is supported by a second annular groove 58 in the separator 38 and an annular groove in the end cap 36.

In operation, the preload air chamber 31 and third spring 56 exert a preload force through the separator 38 onto the second spring 50. The first spring rate provided by the preload air chamber 31 and the third spring 56 are arranged in parallel reducing the spring length that would otherwise be needed with only one spring. The second spring 50 is in series with the preload air chamber 31 and the third spring 56 so that the equivalent spring rate may be expressed as:

$${k}_{eq} = \frac{{k}_{2} ( {k}_{3} + {k}_{2} )}{{k}_{1} + {k}_{2} + {k}_{3}} . \qquad Equation 1$$

As the air pressure with the chamber 48 is decreased, for example as the vehicle operator evacuates air, the preload is reduced. The separator 38 moves upward under the force of the second spring 50 and the third spring 56 is compressed. As a result, the vehicle ride is softened. The reverse is true if the air chamber 48 is pressurized.

Since the spring rate provided by the preload air chamber 31 is arranged in series to the second spring 50, the separator 38 travels less than the prior art during a shock stroke reducing wear of the seals 44. The separator 38 travel moves a reduced amount proportional to prior art systems that can be represented by the following equation:

$$\frac{{k}_{2}}{{k}_{1} + {k}_{2} + {k}_{3}} . \qquad Equation 2$$

Although a preferred embodiment of this invention has been disclosed, a worker of ordinary skill in this art would recognize that certain modifications would come within the scope of this invention. For that reason, the following claims should be studied to determine the true scope and content of this invention.

1. A preload shock absorber assembly comprising:
a shock absorber having a hydraulic cylinder; and
first, second and third springs arranged outside of said hydraulic cylinder, said first spring having a compressible fluid providing a first spring rate, said second spring arranged axially from said first spring, and said third spring arranged at least partially coaxially to said first spring.

2. The assembly according to claim 1, wherein said shock absorber includes a cylinder head at one end of said hydraulic cylinder slideably supporting a rod with a seal between said rod and said cylinder head, and a cavity adjacent to said seal and radially inward of said first spring, said cavity at approximately atmospheric pressure in a static condition.

3. The assembly according to claim 2, wherein said first spring is arranged radially outward of said hydraulic cylinder.

4. The assembly according to claim 1, wherein said first spring is provided by walls forming a pressurized, sealed air chamber, and said third spring arranged in said air chamber.

5. The assembly according to claim 4, wherein an axially movable separator provides one of said walls, said separator arranged axially between said first and second springs.

6. The assembly according to claim 5, wherein said second spring is supported between said separator and a seat secured to said hydraulic cylinder.

7. The assembly according to claim 4, wherein said air chamber is arranged radially outwardly from a rod seal slideably supporting a rod of said hydraulic cylinder.

8. A preload shock absorber assembly comprising:
a shock absorber having a hydraulic cylinder with a seat secured to an outer wall of said cylinder;
a preload air chamber having a pressurized compressible fluid with said air chamber arranged radially outwardly of said outer wall of said hydraulic cylinder; and
a second spring arranged between said air chamber and said seat.

9. The assembly according to claim 8, wherein a third spring is arranged within said air chamber.

10. The assembly according to claim 9, wherein said air chamber includes an axially movable separator, and said pressurized air and said third spring exerting a preload on said second spring.

11. A preload shock absorber assembly comprising:
a shock absorber having a hydraulic cylinder with an outer wall;
an air chamber providing a first spring rate arranged radially outwardly from said outer wall; and
a mechanical spring arranged within said air chamber providing a second spring rate supplementing said first spring rate.

12. The assembly according to claim 11, wherein a seat is secured to said outer wall, and a second spring is arranged between said seat and said air chamber.

13. The assembly according to claim 11, wherein said air chamber includes an axially movable separator arranged between said mechanical spring and said second spring with said first spring rate and said second spring rate exerting a force on said second spring.
